(19) United States
(12) Patent Application Publication
(10) Pub. No.: US 2002/0161596 A1
(43) Pub. Date: Oct. 31, 2002

(54) System and method for validation of storage device addresses

(76) Inventors: Robert E. Johnson, Auburn, CA (US); Paulene Purdy, Roseville, CA (US)

Correspondence Address: HEWLETT-PACKARD COMPANY, Intellectual Property Administration, P.O. Box 272400, Fort Collins, CO, 80527-2400, US

(21) Appl. No.: 09/845,839

(22) Filed: Apr. 30, 2001

(51) Int. Cl. G06F 17/60

(52) U.S. Cl. 705/1

(57) ABSTRACT

A system and method for the validation of devices (preferably device addresses) in an enterprise environment is provided. In one embodiment, a host agent of an enterprise environment queries the storage device(s) embedded in or communicatively coupled to a host system associated with the agent for device identification information. Preferably, the host agent then compares the returned information to some or all of the information stored for the queried device(s) at the host system, which preferably includes address information. If for a device, the stored information matches the returned information, the address information for the device stored at the host system is accepted as valid. In at least one embodiment, additional validation steps are performed before the address information is accepted as valid. If, on the other hand, the information does not match, the host agent(s) flags the stored information as invalid and corrective action is taken.

### BACKGROUND

Businesses, as well as other organizations, often own and operate sizeable computer systems. Such sizeable computer systems are sometimes referred to in the art as enterprise environments or enterprise systems. Any portion of an enterprise environment that is monitored and managed as a unit may be referred to as a host system. The contents of a host system may range from a single client device or server device to a plurality of server devices, client devices, peripheral devices, connector devices, and more.

In addition, a host system may include one or more data storage devices or have one or more data storage devices communicatively coupled thereto. The list of storage devices that may be embedded in or communicatively coupled to a host system includes hard drives, disk drives, compact disc (CD) drives, high capacity disk drives, JBODs (Just a Bunch Of Disks), tape drives, tape libraries, disk arrays, mid-range disk arrays, high-end disk arrays (e.g., Hewlett Packard SureStore™ Disk Array XP256), stackers, drivers, and warehouses, as well as other data storage devices now known or later developed. Storage devices may be communicatively coupled to a host system through any one of numerous means to include a SCSI (Small Computer System Interface) interface, a fibre channel interface, and/or a data network interface. Normally, particularly in enterprise environments, these storage devices are assigned a physical and/or logical address.

A host system also typically includes operating system software executing thereon that manages the basic operations of the host system. Operating systems often employed in host systems include HP-UX®, Windows NT®, Windows 2000®, Linux, AIX®, Sun®, Solaris®, and the like. On at least some occasions, two or more host systems of an enterprise environment have different operating systems.

In addition to the above, to ensure the gathering and processing of information in an efficient and organized manner, enterprise environments often include management or administration systems that oversee the operation of one or more aspects of the enterprise environment. Included in some management/administration systems is a storage management system whose responsibility it is to manage and monitor the operation of the storage devices embedded in or communicatively coupled to the various host systems of the enterprise environment. In at least one instance, the storage management system includes storage management software running on a designated computer or group of computers included in or connected to the enterprise environment.

Oftentimes, in carrying out its task of managing and monitoring the storage devices of an enterprise environment, the storage management system attempts to communicate with a particular storage device of the enterprise environment. As part of this attempt at communication, the storage management system sends inquiries, commands, etc., to what the storage management system presently believes is the address, be it physical or logical, of the particular device with which it desires to communicate.

However, in some circumstances, the operating system for a host system of the enterprise environment will re-map one or more storage devices embedded in or communicatively coupled thereto into addresses previously identified with other storage devices or into new addresses altogether. Such a situation occurs, e.g., when the host system is re-booted, particularly in situations where storage devices were added to or removed (or uncoupled) from the host system since the last time the host system was re-booted or started-up. As an example, with at least one operating system known in the art, upon re-booting, the operating system starts to sequentially assign addresses to the storage devices embedded in or communicatively coupled to the host system. Therefore, if new storage devices have been added or if old storage devices have been removed since the last system start up or re-boot, at least some of the storage devices embedded in or communicatively coupled to the host system will be re-mapped into different device addresses and/or new addresses altogether during this sequential assignment of addresses.

Therefore, in the above scenario, when the storage management system sends the inquiries, commands, etc., discussed earlier to the address it understands to be the present address of the device it is attempting to communicate with, in actuality, the storage management system may be sending the inquiries, commands, etc., to a different storage device. As a result, the storage management system may behave in an unpredictable manner, thereby failing to properly carry out its task of monitoring and managing the storage devices of the enterprise environment.

### SUMMARY OF THE INVENTION

The present invention is directed to a system and method for the validation of devices, preferably device addresses. In one embodiment, a host agent residing on a host system having one or more storage devices embedded in or communicatively coupled thereto acquires device identification information for the one or more storage devices (as an example, standard device inquiry information such as Product ID, Vendor ID, and/or Product Revision information) via an inquiry(ies) to the device(s). The host agent then compares the acquired identification information to information stored at the host system for the one or more storage devices, said information having been acquired during device discovery (preferably during the most recent discovery polling period). If the information matches, then the address stored at the host system for the device(s) may be accepted as valid. In at least one embodiment, additional validation steps are performed before the stored device address(es) is so accepted. If the compared information does not match, the host agent may flag the stored information as invalid and corrective action may be taken.

It should be recognized that one technical advantage of one aspect of at least one embodiment of the present invention is that it ensures the address information stored for the one or more storage devices is valid and current. Therefore, when a storage management system or other element of a network environment attempts to communicate a command, inquiry, etc., to a storage device, the command, inquiry, etc., is directed to the appropriate address.

### BRIEF DESCRIPTION OF THE DRAWING

FIG. 1 depicts an exemplary arrangement of an enterprise environment in accordance with an embodiment the present invention;

FIG. 2 depicts an exemplary embodiment of an embedded storage configuration;

FIG. 3 depicts an exemplary embodiment of a directly attached storage configuration;

FIG. 4 depicts an exemplary embodiment of a directly attached shared storage configuration;

FIG. 5 depicts an exemplary embodiment of a network attached storage configuration;

FIG. 6 depicts an exemplary embodiment of a storage area network configuration;

FIG. 7 depicts an exemplary flow diagram of an embodiment of a method of the present invention for the validation of storage device addresses; and

FIG. 8 depicts a block diagram of a computer system which is adapted to use the present invention.

### DETAILED DESCRIPTION

FIG. 1 depicts an exemplary enterprise environment arranged according to an embodiment of the present invention. Included in enterprise environment 100 of FIG. 1 are one or more host systems, illustrated in FIG. 1 as host systems 101-1, 101-2, and 101-n. In the embodiment of FIG. 1, residing on each of host systems 101-1, 101-2, and 101 -n are one or more host agents, represented in FIG. 1 as agent(s) 106-1, 106-2, and 106-n. In addition, embedded in or communicatively coupled to each of the one or more host systems are one or more data storage devices, illustrated in FIG. 1 as storage device(s) 102-1, 102-2, and 102-n. In an alternative embodiment, at least one of the host systems of enterprise environment 100 has no storage device(s) embedded in or attached thereto. In addition to being communicatively coupled to storage device(s) 102-1, 102-2, and 102-n, in the embodiment of FIG. 1, host systems 101-1, 101-2, and 101-n are also communicatively coupled to data network 103. In at least some embodiments, storage device(s) 101-1, 101-2, and 101-n are coupled to data network 103 as well (not shown in FIG. 1). In addition to the above systems and devices, storage management system 104 is also communicatively coupled to data network 103 in the embodiment of FIG. 1.

Similar to the earlier discussion regarding host systems, host systems 101-1, 101-2, and 101-n may include any number of computers and related devices (including for example input and output devices, such as displays, speakers, keyboards, pointing devices, printers, etc.). As previously mentioned, in the embodiment of FIG. 1, residing on each of host systems 101-1, 101-2, and 101-n, are host agent(s) 106-1, 106-2, 106-n respectively. A host agent may be implemented as an executable program that exists as a running process or service on a host system of enterprise environment 100 (as is the case with host agent(s) 106-1, 106-2, and 106-n of FIG. 1). Furthermore, typically a host agent comprises various components for various tasks. In addition, generally a host system has only one host agent residing thereon. However, a host system may have a plurality of host agents residing on the host system. For instance, for host systems that include a plurality of server devices, each server device may have a host agent residing thereon.

Also similar to earlier discussions, storage device(s) 102-1, 102-2, and 102-n may include any number of numerous known or later developed data storage devices to include hard drives, disk drives, compact disc (CD) drives, high capacity disk drives, JBODs (Just a Bunch Of Disks), tape drives, tape libraries, disk arrays, mid-range disk arrays, high-end disk arrays (e.g., Hewlett Packard SureStore™ Disk Array XP256), stackers, drivers, warehouses, and the like.

Each of the connections shown in FIG. 1 between a host system (e.g., host system 101-1) and a storage device(s) (e.g., storage device(s) 102-1) is a simplified block diagram representation of the actual connection(s) that may occur between the host system and the storage device(s). It will be appreciated that the actual arrangement of the connection between the storage device(s) and the host system may take on many forms.

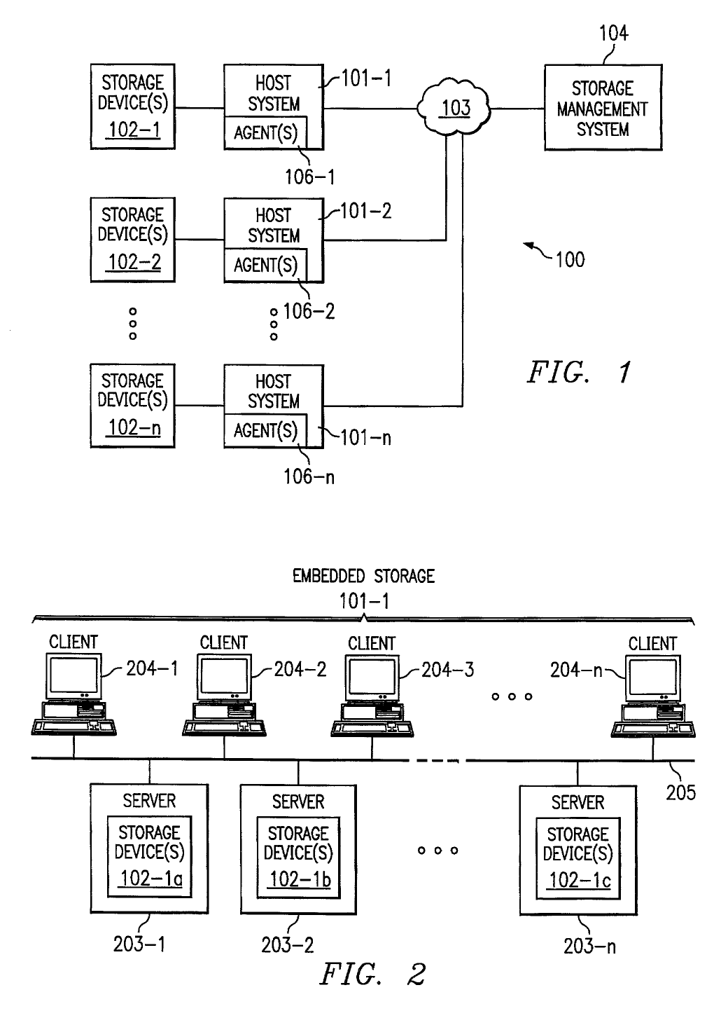

For example, the host system and storage device(s) may be arranged in an embedded storage configuration, wherein the storage device(s) are embedded in some component(s) of the host system. FIG. 2 provides one example of such a configuration. In the embodiment of FIG. 2, host system 101-1 includes one or more client devices, represented in FIG. 2 as clients 204-1, 204-2, 204-3, and 204-n, and one or more server devices, represented in FIG. 2 as servers 203-1, 203-2, and 203-n. The client devices and server devices of FIG. 2 are communicatively coupled to each other by way of connection 205. Connection 205 may be any one of numerous known means for communicatively coupling computers to include data network connections (e.g., a local area network (LAN), metropolitan area network (MAN), or wide area network (WAN) connection), USB (Universal Serial Bus) connections, SCSI connections, fibre channel connections, IDE (Integrated Drive Electronics) connections, etc. As can be seen, in the embedded storage configuration of FIG. 2, storage device(s) 102-1a, 102-1b, and 102-1c, representing storage device(s) 102-1 in FIG. 2, are embedded in servers 203-1, 203-2, and 203-n.

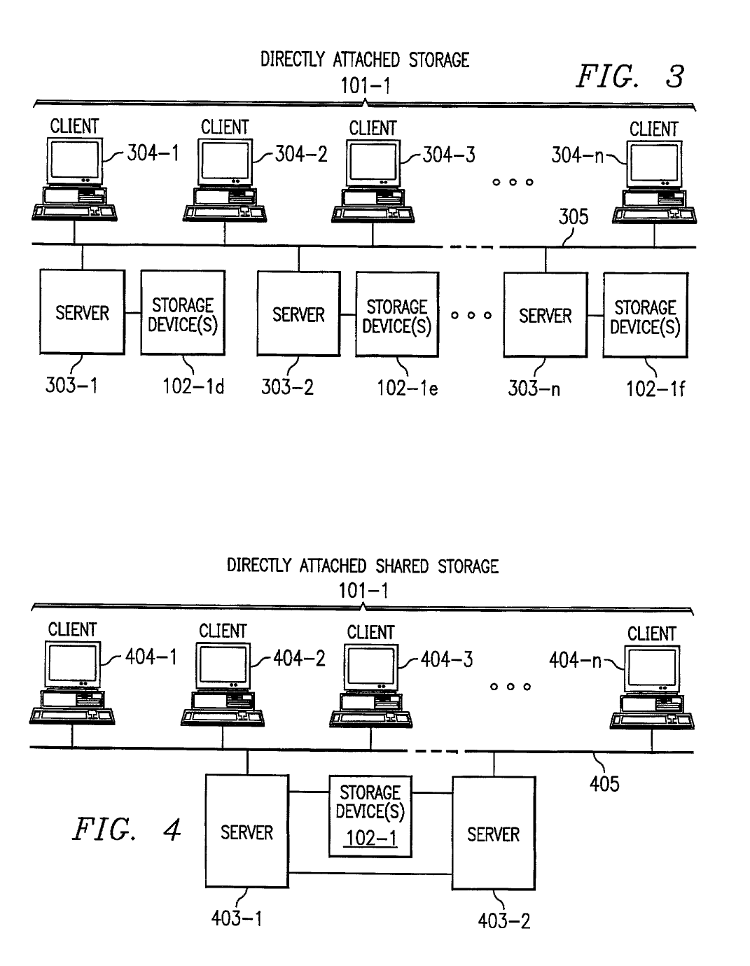

Rather than an embedded storage configuration, the storage device(s) and host system may be arranged in a directly attached storage configuration. FIG. 3 provides one example of such a configuration. In the embodiment of FIG. 3, host system 101-1 includes one or more client devices, represented in FIG. 3 as clients 304-1, 304-2, 304-3, and 304-n, and one or more server devices, represented in FIG. 3 as servers 303-1, 303-2, and 303-n. The client devices and server devices of FIG. 3 are communicatively coupled to each other by way of connection 305. Similar to connection 205, connection 305 may be any one of numerous known means for communicatively coupling computers to include data network connections (e.g., a LAN, MAN, or WAN connection), USB connections, SCSI connections, fibre channel connections, IDE connections, etc.

In the directly attached storage configuration of FIG. 3, each of storage device(s) 102-1d, 102-1e, and 102-1f (representing storage device(s) 102-1 in FIG. 3) are each directly attached to, rather than embedded in, one of servers 303-1, 303-2, and 303-n. The connection between one of storage device(s) 102-1d, 102-1e, and 102-1f and one of servers 303-1, 303-2, and 303-n may be any one of numerous known means for directly coupling a computer to a storage device to include a USB connection, a serial port, a SCSI interface, an IDE connection, etc.

On the other hand, as an alternative, the storage device(s) and host system may be arranged in a directly attached shared storage environment. FIG. 4 provides one example of such a configuration. In the embodiment of FIG. 4, host system 101-1 includes one or more client devices, represented in FIG. 4 as clients 404-1, 404-2, 404-3, and 404-n, and one or more server devices, represented in FIG. 4 as servers 403-1 and 403-2. The client devices and server devices of FIG. 4 are coupled to each other by way of connection 405.

Similar to connection 205, connection 405 may be any one of numerous known means for communicatively coupling computers to include data network connections (e.g., a LAN, MAN, or WAN connection), USB connections, SCSI connections, fibre channel connections, IDE connections, etc.

In the directly attached shared storage configuration of FIG. 4, each of servers 403-1 and 403-2 are directly attached to storage device(s) 102-1. The connection between servers 403-1 and storage device(s) 102-1, as well as the connection between server 403-2 and storage device(s) 102-1, may be any one of numerous known means for directly coupling a computer to a storage device to include a USB connection, a serial port, a SCSI interface, an IDE connection, etc. Furthermore, in the embodiment of FIG. 4, in addition to their connections to storage device(s) 102-1, servers 403-1 and 403-2 are also coupled to each other.

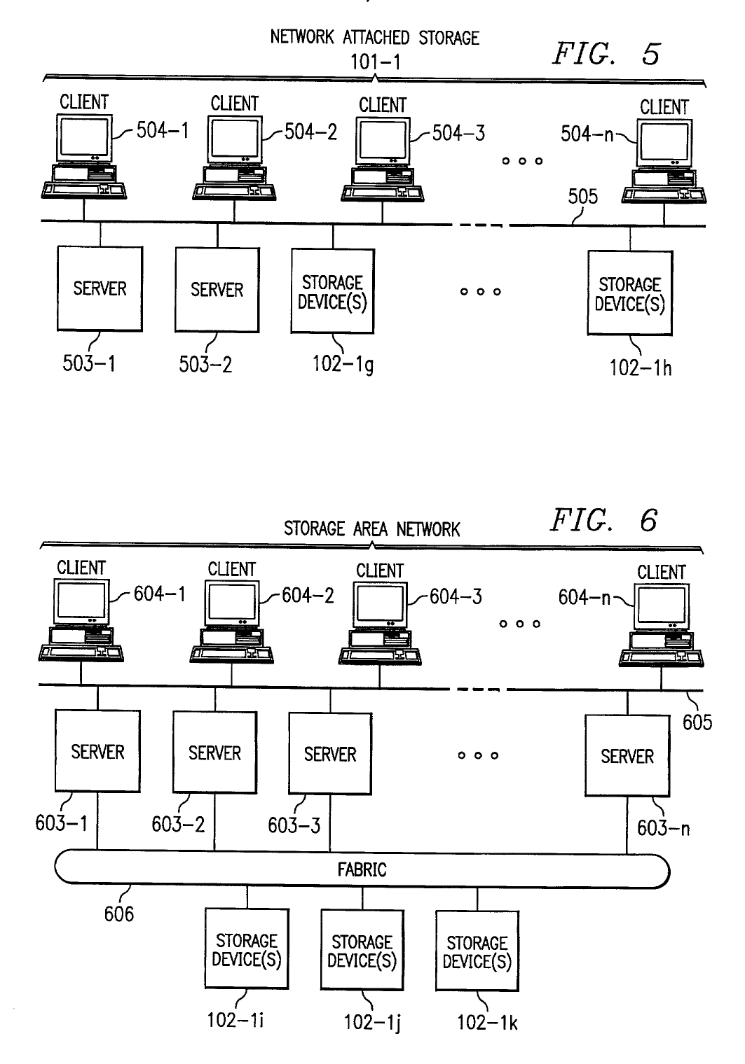

However, rather than the earlier described directly attached configurations, a host system and a storage device(s) may be arranged in a network attached storage configuration. FIG. 5 provides one example of this type of configuration. In the embodiment of FIG. 5, host system 101-1 includes one or more client devices, represented in FIG. 5 as clients 504-1, 504-2, 504-3, and 504-n, and one or more server devices, represented in FIG. 5 as servers 503-1 and 503-2. The client devices and server devices of FIG. 5 are communicatively coupled to each other by way of connection 505. However, in the embodiment of FIG. 5, also communicatively coupled to the clients and servers by way of connection 505 are storage device(s) 102-1g and 102-1h (these devices representing storage device(s) 102-1 in FIG. 5). In the embodiment of FIG. 5, connection 505 represents any one of numerous known data network connections (e.g., a LAN, WAN, or MAN connection).

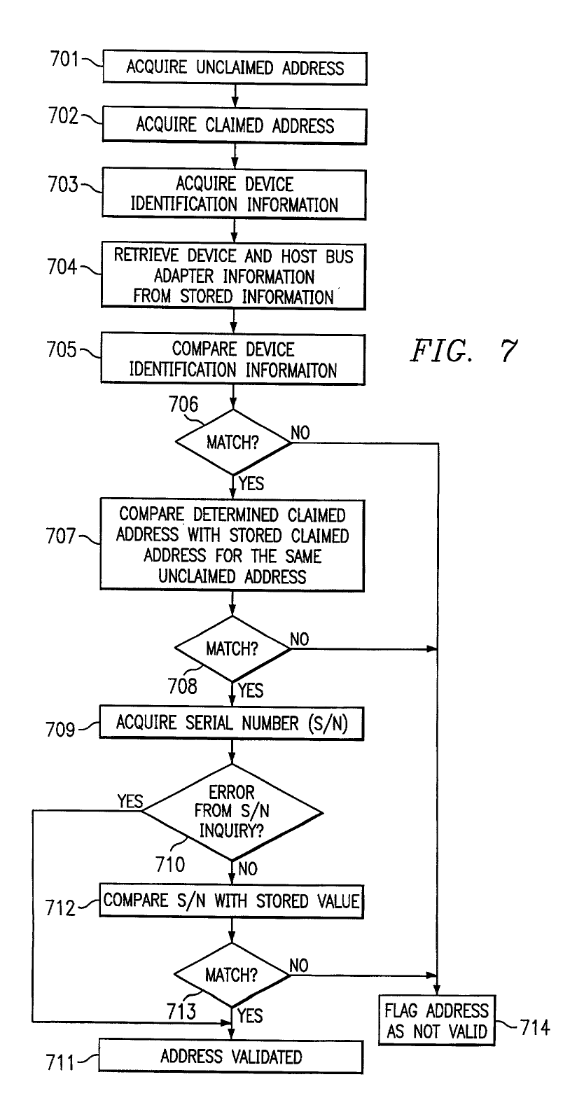

Moreover, rather than a network attached storage configuration, a host system and a storage device(s) may be arranged in a storage area network (SAN) configuration. FIG. 6 provides one example of this type of configuration. In the embodiment of FIG. 6, host system 101-1 includes one or more client devices, represented in FIG. 6 as clients 604-1, 604-2, 604-3, and 604-n, and one or more server devices, represented in FIG. 6 as servers 603-1, 603-2, 603-3, and 603-n. The client devices and server devices of FIG. 6 are coupled to each other by way of connection 605. Similar to connection 205, connection 605 may be any one of numerous known means for communicatively coupling computers to include data network connections (e.g., a LAN, MAN, or WAN connection), USB connections, SCSI connections, fibre channel connections, IDE connections, etc.

However, in the embodiment of FIG. 6, in addition to being communicatively coupled to clients 604-1, 606-2, 604-3, and 604-n, servers 603-1, 603-2, 603-3, and 603-n are communicatively coupled to storage device(s) 102-1i, 102-1j, and 102-1k via fabric 606. In at least one embodiment, fabric 606 may includes one or more known network connection devices such as switches, hubs, bridges, routers, and/or the like. Storage device(s) 102-1i, 102-1j, and 102-1k represent storage device 102-1 in FIG. 6.

In alternative embodiments, rather than being communicatively coupled via fabric 606, clients 604-1, 604-2, 604-3, and 604-n, as well as servers 603-1, 603-2, 603-3, and 603-n, may be communicatively coupled to storage device(s) 102-1i, 102-1j, 102-1k via a fibre channel arbitrated loop or a fibre channel point to point connection configuration.

It will be appreciated by one of ordinary skill in the art that the configurations shown in FIGS. 2, 3, 4, 5, and 6 are by way of example only, for various other configurations may be employed, to include any combination of the above configurations. Moreover, the host systems depicted in FIGS. 2, 3, 4, and 5 are by way of example only, for as described earlier, a host system may include any number of computers and related devices. Therefore, as an example, in the configuration of FIG. 2, in addition to client devices and server devices, peripheral devices, e.g., a printer(s), may also be included in host system 101-5.

In the embodiment of FIG. 1, in addition to being communicatively coupled to storage devices 102-1, 102-2, and 102-n, as mentioned, host systems 101-1, 101-2, and 101-n may also be communicatively coupled to data network 103. In at least one embodiment, one or more of storage devices 102-1, 102-2, and 102-n are also communicatively coupled to data network 103. Data network 103 may be any one of numerous data networks to include a LAN, a MAN, a WAN, or a larger network. Data network 103 may be implemented utilizing any number of communication mediums and protocols.

In addition to the storage devices and host systems of enterprise environment 100, storage management system 104 may also be communicatively coupled to data network 103. Similar to previous discussions, storage management system 104 monitors and manages the storage devices of enterprise environment 100. Storage management system 104 may include storage management software running on one or more designated computer devices.

In the operation of at least one embodiment of storage management system 104, system 104 allows a network administrator to monitor and manage storage for enterprise environment 100 via a user interface on storage management system 104 or one of host systems 101-1, 101-2, and 101-n. Preferably, storage management system 104 autonomously performs some or all of these management or monitoring tasks utilizing policy driven criteria. For example, data paths may be reconfigured in the event of a broken communication link. Additionally, data paths may be automatically added or removed to allocate bandwidth to particular applications or users to minimize waiting time or to perform other desired goals.

In an embodiment of the present invention, storage management system 104 receives device discovery information, to include path status information, from one or more host systems of enterprise environment 100 (e.g., host systems 101-1, 101-2, and 101-n). For example, in at least one embodiment, storage management system 104 receives such information from the host agents of enterprise environment 100, e.g., agent(s) 106-1, 106-2, and 106-n of FIG. 1. For purposes of this disclosure, the phrases “device discovery” and “device identification” refer to the quantification and qualification of manageable storage-related components in a computing environment (e.g., enterprise environment 100). In at least one embodiment, as part of this quantification and qualification, one or more input/output (I/O) paths are examined and the storage-related device(s) associated with each path, among other things, are determined. These storage-related devices may be physical, logical, and/or virtual storage-related devices.

Moreover, in at least some embodiments, Logical Unit Number (LUN) information is discovered as well. The storage in a storage device may comprise one or more addressable entities referred to as Logical Units. Each Logical Unit may be addressed by a host system(s) using a Logical Unit Number (LUN) associated with the particular Logical Unit. A storage device LUN(s) is defined by an open system protocol designed to coordinate communication or to define logical connection between a host and a plurality of I/O paths associated with various devices. As can be seen, depending upon the number of Logical Units within a storage device, a storage device may have more than one LUN associated therewith. Each host I/O path will point to one storage device LUN. In at least one embodiment, when querying a storage device, using, e.g., SCSI or Fibre channel protocol standards, the LUN is part of the address information required to access the storage device.

In addition to or in lieu of the above, device discovery may also include discovering software components, data and data structures, associations, enterprise processes, enterprise policies, and/or path information (e.g., path status) associated with the storage-related device(s) for a particular input/output (I/O) path.

In at least one embodiment, each of the host agents of enterprise environment 100 (e.g., agent(s) 106-1, 106-2, and 106-n) perform device discovery at least in part, through queries made to storage devices pursuant to SCSI protocols. In addition to SCSI inquiries, storage device (as well as other related) information may be acquired through system files and/or a system registry(ies) (e.g., in a Windows OS environment), Operating System (OS) Kernel Application Programming Interface (API) calls, and/or host bus adapter device driver library APIs (e.g., standard SNIA library provided by host bus adapter vendors). Moreover, device information can also be discovered through bus scanning, which, in at least one embodiment, involves stepping through all of the SCSI or Fibre channel addresses and sending SCSI inquiries to discover any storage devices that reply. Furthermore, in at least some embodiments, in addition to or in lieu of the host agents, some portion of the host system(s) of enterprise environment 100 other than the host agent(s) residing on the host system(s) performs device discovery. Device discovery may also be performed through some combination of the above.

Device discovery is normally performed during discovery polling periods. Generally, each host agent (and/or other portion(s) of the host systems) has its own polling periods, one for device discovery and one for device status checks. Generally, the information collected during the polling periods is kept locally at the host system and updated continuously as needed when new information is found during the host device discovery and device status checks. In addition, in at least one embodiment of the present invention, the number of times device discovery is performed, the duration of the polling period, and/or the period of time between each polling period are configurable variables that may be set by an administrator of enterprise environment 100, as well as other individuals.

The information obtained by a host agent (and/or other portion(s) of a host system) during a single discovery polling period may include any and all information useful in the management and monitoring of storage devices, to include device address information. The host agent(s) (and/or other portion(s) of the host system(s)) may also supplement the information obtained from the storage devices with additional information. Examples of the types of information that may be collected during a single discovery period include information relating to the host on which a host agent is running (e.g., name, type, size, description, timestamp of last discovery polling period, host system operating system type and/or version, host model/architecture, serial number, Java Version and related information (if applicable), address information (e.g., host system network IP address), and more); information about the agent itself (e.g., name, type, size, description, version, build, copyright information, discovery polling period, status polling period, and more); device and LUN information (e.g., name, type, size, description, address, vendor ID, product ID, serial number, product revision, topology, host bus adaptor (HBA) name, status, capacity, path status, world wide name, unique ID, Bus ID, Target ID, Port ID, LUN ID, and more); host bus adaptor (HBA) information(e.g., name, type, size, description, address, unique ID, world wide name, manufacturer name, model, serial number, firmware version, driver version topology, port world wide name, node world wide name, fabric name, port max speed, port current speed, number of discovered ports that a particular port can communicate with, HBA index, and more); topology information (e.g., topology relationship between the host system and storage devices); path status information; software information (e.g., application name, vendor, version(s), and patch-level(s), and more); data and data structure information; association target information; policy and process information; and more.

In at least one embodiment, each of the host agents of enterprise environment 100 (e.g., agent(s) 106-1, agent(s) 106-2, and agent(s) 106-3) provide an Application Programming Interface (API) that may be used by storage management system 104 to communicate with the host agents, to include retrieving the above described information. Moreover, one or more of the host agents may have a generic storage device discovery engine from which storage management system 104 may obtain the above-described information as well.

As mentioned, after the information described above is collected during a discovery polling period, the information is stored locally at the host performing the discovery. In at least one embodiment, simultaneous with storage at the host system or some point thereafter, the stored discovery information, which in at least one embodiment includes address information, is provided to storage management system 104. At storage management system 104, the provided discovery information is processed and stored. This stored information may then be used by storage management system 104 when performing its task of monitoring and managing the storage devices of enterprise environment 100. For example, the stored address information may be used by storage management system 104 and/or associated applications to determine where to direct certain commands, inquiries, etc.

In various embodiments of the present invention, preferably at start-up and/or during each discovery polling period, one or more of the host systems of enterprise environment 100 (e.g., one or more of host systems 101-1, 101-2, and 101-n) executes a validation routine to validate one or more of the storage devices of enterprise environment 100. In at least one embodiment, such validation of the one more storage devices involves ensuring that the address information presently stored at the host(s) and/or storage management system 104 is valid and current. In at least one embodiment, the host agents of enterprise environment 100 (e.g., agents 106-1, 106-2, and 106-n) perform this routine.

FIG. 7 provides an exemplary flow diagram for an embodiment of the above mentioned validation routine. In the embodiment of FIG. 7, a host agent embedded in a host system of enterprise environment 100 acquires the unclaimed address of one or more storage devices associated with the input/output (I/O) paths of the host system on which said agent resides (box 701). The particular method for acquiring the storage device's(s') unclaimed address information depends upon the operating system for the host system. In at least one embodiment, unclaimed address information is acquired through Operating System API calls (e.g., in Windows® and HP-UX®), Operating System Kernel API calls, system files, and/or registry entries. In at least some embodiments, particularly embodiments where bus scanning discovery may be employed, unclaimed address information may be acquired through SCSI inquiries.

Generally, unclaimed address information is used locally on the host by the host agent for discovery of devices. Unclaimed address information may vary according to operating system. For example, for Windows®, unclaimed address information includes Port ID, Bus ID, Target ID, and LUN ID. The unclaimed address information for HP-UX®, on the other hand, includes much of the same information as Windows® (however, not Port ID), as well as additional information. Moreover, in the Windowsg Operating System, in addition to the requested unclaimed address information, when an API call for the unclaimed address information is made, additional information is returned, e.g., Vendor ID, Product ID, and Product Revision information.

Preferably, after the host agent acquires the unclaimed address information for the storage device(s), the host agent then acquires the claimed address for the storage device(s) (box 702). Claimed address information includes the address information an operating system associates with a particular device. As was the case with unclaimed address information, claimed address information may vary depending on the operating system of the host system.

In at least one embodiment of the present invention, the host agent acquires the claimed address information for a device(s) with the aid of the operating system of the host system by looping through the claimed addresses assigned by the operating system to the storage devices embedded in or communicatively coupled to the host system (e.g., physicaldriveX, tapeX, driveletterX, etc.). Particularly, the host agent loops through each claimed address one at a time and retrieves the unclaimed address information the operating system associates with the particular claimed address. If any of these unclaimed addresses matches the unclaimed address information acquired at box 701, then the claimed address for that particular device is determined to be the claimed address associated with the unclaimed address retrieved during this loop process that matches the unclaimed address information acquired at box 701.

In at least one embodiment, only devices that are used by the operating system and that have a driver associated therewith are assigned a claimed device address, device file, or the like. Therefore, a device may not have a claimed address if it has not been configured for operation on the host system, or not have a driver installed/configured, etc.

In a preferred embodiment, after the host agent determines the claimed address information for the one or more storage device(s) of the host system, the host agent acquires device identification information, such as standard device inquiry information (e.g., standard SCSI inquiry data such as Vendor ID, Product ID, Product Revision information, World Wide Name, Serial Number, peripheral qualifier, peripheral device type, Removable Medium or Not Removable Bit (RMB), International Standards Organization (ISO) version, European Computer Manufacturer's Association (ECMA) version, American National Standards Institute (ANSI)-approved version, Asynchronous Event Notification Capability (AENC), vital product data specified by the page code field, etc.) for at least one of the storage devices via an inquiry(ies) to the device(s) (e.g., via SCSI inquiry(ies)) (box 703). In such an embodiment, the inquiry(ies) is sent to the acquired claimed or unclaimed address(es) for the device(s) determined above, depending upon whichever is appropriate for the operating system and whether a claimed address is available.

In at least one embodiment, e.g., embodiments wherein the host system runs Windows®, certain device identification information such as Vendor ID, Product ID, and Product Revision information is provided in response to Operating System API calls for unclaimed address information. Accordingly, a separate inquiry to the device(s) for this information is not required.

Preferably, after the host agent receives the requested device identification information (e.g., Vendor ID, Product ID, Production Revision information), the host agent retrieves at least some portion of the discovery information stored at the host system for the queried device(s). In at least one embodiment, the information retrieved by the host agent is the stored device and host bus adapter information (box 704). In a preferred embodiment, the information retrieved from the host system is the device and host bus adapter information acquired during the last discovery polling period prior to the initiation of the validation routine.

Once the device and host bus adapter information is retrieved from the host system, the host agent compares at least a portion of the retrieved portion of the stored discovery information (e.g., at least a portion of the stored device and host bus adapter information) with at least a portion of the device identification information provided by the device at box 703 (box 705). For example, the host agent may only compare Vendor ID, Product ID, and Product Revision information.

If the information matches (block 706), the host agent may accept the address stored at the host system for the queried device as valid. On the other hand, the host agent may instead perform additional tests to ensure the validity of the address.

For example, in at least one embodiment, if the information at block 706 matches, the host agent then retrieves the claimed address information stored at the host system for the queried device and compares the stored claimed address information (or some subset thereof) to the claimed address information determined at box 702 (box 707). Preferably, the information retrieved from the host system is the claimed address information acquired during the last discovery polling period prior to the initiation of the validation routine.

If the information matches (block 708), again, the host agent may accept the address stored at the host system for the queried device as valid. On there hand, the host agent may instead perform additional tests to ensure the validity of the address. For example, in at least one embodiment, after determining that the claimed address information matches as well, the host agent may communicate another validation inquiry(ies) (e.g., a SCSI inquiry) to the device requesting the device's serial number (block 709).

In at least one embodiment, if the host agent receives a serial number in response to its second validation inquiry(ies) (block 710), the host agent compares the received serial number to the serial number stored at the host system for the queried device (block 711). Preferably, the serial number stored at the host system that is compared to the serial number returned at block 710 is the serial number acquired during the last discovery polling period prior to the initiation of the validation routine.

If the serial numbers match (block 712), the host agent may again perform additional tests to ensure validity of the address stored at the host system. However, in the embodiment of FIG. 7, the host agent designates the address as valid (block 713).

In at least one embodiment, if the storage device returns an error while trying to access the serial number (block 710), preferably then the address is considered valid (block 713). On the other hand, the host agent may perform additional tests to ensure the validity of the address stored at the host system for the queried devices.

However, in an alternative embodiment, if an error is returned in response to an inquiry for a device serial number, the host agent may review the information stored at the host system for the queried device to determine whether an error was returned during the last inquiry for the device serial number.

If at any time during the above steps the host agent determines that the information provided by the queried device or determined by the host agent does not match the information stored at the host system, in at least one embodiment, the host agent flags the address information as non-valid and corrective action is taken (block 714).

In at least one embodiment, when a device address is flagged as non-valid at box 714, then the device information stored at the host system for the queried device is deleted and an event is transmitted to storage management system 104 requesting the storage management system to delete or update the queried device's information in storage management system 104's database(s). The new information obtained by the host agent during the validation routine is then added to the host system as a new device and an event is transmitted to storage management system 104 to include or update the device's information in its database(s).

It will be appreciated that the above steps, as well as the order of the steps, are by way of example only, for embodiments of the present invention may include more or fewer steps, as well as a different order to the steps. For example, as mentioned, the validation routine need not include step 703 wherein standard device inquiry information (e.g., Vendor ID, Product ID, and Product Revision Information) is returned along with the unclaimed address information. On the other hand, the above validation routine may include an additional validation step occurring after the information is updated at storage management system 104 so as to protect against any re-mapping of device addresses that may occur during the short time frame that the device information is being updated at storage management system 104.

It will also be appreciated that the host agent for a particular host system may perform the above steps with respect to a plurality of storage devices continuously or simultaneously. Moreover, in at least one embodiment of the present invention, the validation routine is performed by a portion of the host system other than a host agent.

Furthermore, in at least one embodiment, the number of times the validation routine is performed, the time frame for performing the routine, as well as the period of time between each validation routine are configurable parameters that may be set by a system administrator or other personnel.

In addition to the above, embodiment of the present invention also provide several means to ensure that storage management system 104 and/or associated applications do not communicate commands, inquiries, etc., to the incorrect device address, LUN, etc., when the above described information update is in progress. As an example, in at least one embodiment of the present invention, the host agent (or some component therein) operates as a gateway for communications between storage management system 104 and the storage devices embedded in or communicatively coupled to the host system. In such embodiments, the host agent may deny communications from storage management system 104 and/or its associated applications to any device that is the subject of an in-progress address information update.

As another example of the earlier discussed means, in at least one embodiment, when storage management system 104 and/or associated applications desire to communicate with a particular storage device, in addition to the address information discussed earlier, storage management system 104 and/or associated applications also provide information sufficient to uniquely identify the device, LUN ID, etc. This information may be combined into a single unique identifier or may be provided in separate fields. The host agent may then compare this additional information to the information stored at the host system associated with the agent in a manner similar to the validation routine discussed above.

It will be appreciated that although the above examples relate to validation of storage device addresses, embodiments of the present invention may be used to validate the addresses of other network devices.

Various embodiments of the present invention alleviate the problems associated with the prior art by ensuring that the address information stored at storage management system 104 for the storage devices of enterprise environment 100 is valid and current. Therefore, when storage management system 104 desires to communicate a command, inquiry, etc., to a particular storage device, embodiments of the present invention ensure that the command, inquiry, etc., is directed to the appropriate address. Moreover, in at least one embodiment, various embodiment of the present invention also ensure that the storage management system and associated applications do not communicate inquiries and commands to the wrong addresses, LUNs, etc., when an update of information is in progress. Moreover, by sending events to the storage management system to delete or update outdated information, embodiments of the present invention minimize the exposure time of the storage management system to an address re-map after an address information update has taken place.

In certain embodiments of the present invention, when implemented via executable instructions, various elements of the present invention are in essence the code defining the operations of such various elements. For example, as mentioned earlier, the host agent(s) of enterprise environment 100 may be implemented as an executable program(s) that exists as a running process or service on a host system(s) of enterprise environment 100. The executable instructions or code may be obtained from a readable medium, such as a readable medium of a host system or storage device(s) of enterprise environment 100 (e.g., a hard drive media, optical media, EPROM, EEPROM, tape media, cartridge media, flash memory, ROM, memory stick, and/or the like) or communicated via a data signal from a communication medium (e.g., data network 103). In fact, readable media can include any medium that can store or transfer information.

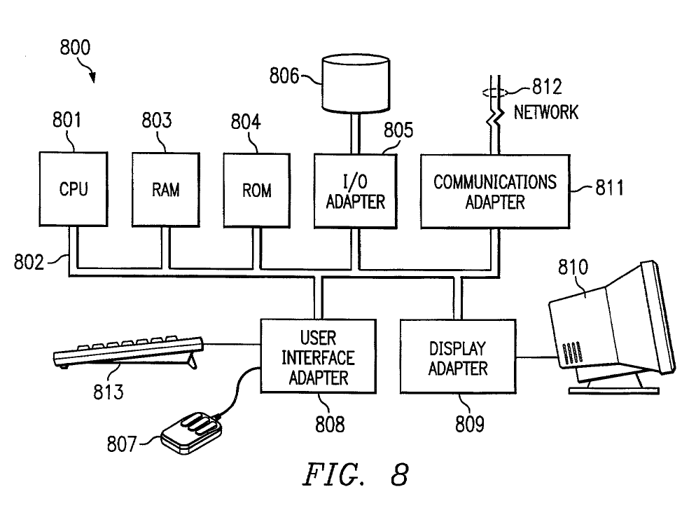

According to various embodiments, one or more of the host systems and/or storage devices of enterprise environment 100, as well as storage management system 104, may comprise a processor based implementation. For example, FIG. 8 shows computer system 800 which may be included within one or more of the host systems and/or storage devices of enterprise environment 100, as well as storage management system 104. In FIG. 8, one or more central processing unit(s) (CPU(s)) 801 is(are) coupled to system bus 802. CPU(s) 801 may be any general purpose CPU, such as an Intel Pentium® processor. However, the present invention is not restricted by the architecture of CPU(s) 801 as long as CPU(s) 801 supports the inventive operations as described herein. Computer system 800 may include bus 802. Computer system 800 may also include random access memory (RAM) 803, which may be SRAM, DRAM, SDRAM. Computer system 800 may further include ROM 804 for holding user and system data and programs as is well known in the art. For example, an agent(s) of a host system of enterprise environment 100 may be stored in RAM, ROM, and/or executed on CPU(s) 801.

Computer system 800 may also include input/output (I/O) controller card 805, communications adapter card 811, user interface card 808, and display card 809. I/O controller card 805 may connect to storage devices 806 (which may be storage device(s) 102-1, 102-2, and/or 102-n of enterprise environment 100), such as one or more of hard drive, CD drive, floppy disk drive, tape drive, etc., to computer system 800. Communications card 811 may also be adapted to couple computer system 800 to network 812 (e.g., data network 103 of FIG. 1), which may be one or more of telephone network, local (LAN) and/or wide-area (WAN) network, Ethernet network, Fibre Channel network, Internet network, and/or the like. User interface card 808 may also couple user input devices, such as keyboard 813 and pointing device 807, to computer system 800. Display card 809 may be driven by CPU 801 to control the display on display device 810.

What is claimed is:

1. A method for validating a storage device, the method comprising:
storing discovery information relating to a storage device;
querying said storage device for device identification information; and
comparing at least a portion of returned device identification information to at least a portion of said stored discovery information.

2. The method of claim 1 wherein said at least a portion of said stored discovery information includes device and host bus adapter information.

3. The method of claim 1 wherein said stored discovery information is obtained through at least one small computer system interface (SCSI) inquiry.

4. The method of claim 2 wherein said stored discovery information is obtained through at least one element selected from the group consisting of:
at least one system file;
at least one system registry; and
combinations thereof.

5. The method of claim 2 wherein said stored discovery information is obtained through at least one element selected from the group consisting of:
operating system kernel application programming interface call;
host bus adapter device driver library application programming interface; and
some combination thereof.

6. The method of claim 1 wherein said at least a portion of said returned device identification information includes Product ID, Vendor ID, and Product Revision information.

7. The method of claim 1 wherein said returned device identification information includes standard device inquiry information.

8. The method of claim 1 wherein said stored discovery information includes device address information.

9. The method of claim 8 wherein said device address information includes claimed address information; and wherein said method further comprises:
determining claimed address information for said storage device; and
comparing said determined claimed address information to said stored claimed address information.

10. The method of claim 9 wherein said method further comprises:
flagging said stored discovery information if said determined claimed address information does not match said stored claimed address information.

11. The method of claim 9 wherein said stored discovery information further includes serial number information for said storage device, and wherein said method further comprises:
querying said storage device for serial number information for said device; and
comparing said serial number information received in response to said serial number information query to said stored serial number information.

12. The method of claim 9 wherein said method further comprises:
querying said storage device for serial number information for said device; and
accepting said stored device address information as valid if an error is returned in response to said query.

13. The method of claim 1 wherein said querying includes at least one small computer system interface (SCSI) inquiry.

14. The method of claim 1 wherein said method further includes flagging said stored discovery information if said at least a portion of said returned information does not match said at least a portion of said stored discovery information.

15. The method of claim 14 wherein said method further comprises:
deleting or updating said stored discovery information if said stored discovery information is flagged.

16. The method of claim 15 wherein said storing discovery information includes storing discovery information on a host system and a storage management system; and wherein said deleting or updating said stored discovery information includes deleting or updating said discovery information stored at said host system and at said storage management system.

17. The method of claim 16 wherein said deleting or updating said stored discovery information stored at said host system further comprises:
transmitting an event to said storage managements system requesting said storage management system to delete or update said discovery information stored at said storage management system.

18. The method of claim 15 wherein said method further comprises:
storing said returned information as a new device.

19. The method of claim 18 wherein said method further comprises:
communicating an event requesting the addition of said returned information or an update of previous information using said returned information.

20. The method of claim 18 wherein said method further comprises:
preventing communication between a storage management system and said device during said storing said returned information as a new device.

21. A system for the validation of a storage device, said system comprising:
means for storing discovery information for a storage device;
means for querying said storage device for device identification information; and
means for comparing at least a portion of device identification information received in response to said query to at least a portion of said stored discovery information.

22. The system of claim 22 wherein said discovery information includes device address information.

23. The system of claim 22 wherein said device address information includes claimed address information for said storage device; and wherein said system further comprises:
means for determining claimed address information for said device;
means for comparing said determined claimed address information to said stored claimed address information; and
means for flagging said stored discovery information if said determined claimed address information does not match said stored claimed address information.

24. The system of claim 23 wherein said discovery information further includes serial number information for said storage device, and wherein said system further comprises:
means for querying said storage device for serial number information for said storage device;
means for comparing said serial number information received in response to said serial number information query to said stored serial number information; and
means for flagging said stored discovery information if said received serial number information does not match said stored serial number information.

25. The system of claim 23 wherein said system further comprises:
means for querying said storage device for serial number information for said device; and
means for accepting said stored device address information as valid if an error is returned in response to said query for serial number information.

26. The system of claim 21 wherein said system further comprises:
means for flagging said stored discovery information if said at least a portion of said received information does not match said at least a portion of said stored discovery information.

27. The system of claim 26 wherein said system further comprises:
means for deleting or updating said stored discovery information if said stored discovery information is flagged.

28. The system of claim 27 wherein said system further comprises:
means for preventing communication between a storage management system and said storage device when said stored discovery information is being deleted or updated.

29. A system for the validation of at least one storage device address comprising:
at least one host system, wherein at least one storage device is embedded in or coupled to each of said at least one host system; and wherein each of said at least one host system stores information relating to said at least one storage device embedded in or coupled thereto; and
at least one host agent process, wherein each of said at least one host agent process resides on a respective host system of said at least one host system;
wherein each of said at least one host agent process is operable to query said at least one storage device embedded in or coupled to said host system on which said host agent process resides for device identification information, as well as to compare information returned by said at least one storage device to at least a portion of discovery information stored for said at least one storage device at said host system to which said at least one storage device is coupled.

30. The system of claim 29 wherein said at least one host agent process queries said at least one storage device during system start up or doing a discovery polling period.
